(19) United States
(12) Patent Application Publication
(10) Pub. No.: US 2025/0296402 A1
(43) Pub. Date: Sep. 25, 2025

(54) THERMAL MANAGEMENT SYSTEM

(71) Applicant: TOYOTA JIDOSHA KABUSHIKI KAISHA, Toyota-shi (JP)

(72) Inventors: Yuji MIYOSHI, Toyota-shi (JP); Takayuki KAWABE, Toyota-shi (JP); Sohichi IMAI, Toyota-shi (JP)

(73) Assignee: TOYOTA JIDOSHA KABUSHIKI KAISHA, Toyota-shi (JP)

(21) Appl. No.: 19/015,047

(22) Filed: Jan. 9, 2025

(30) Foreign Application Priority Data
Mar. 21, 2024 (JP) 2024-045044

(51) Int. Cl. B60H 1/00

(52) U.S. Cl. CPC B60H 1/00899

(57) ABSTRACT

A thermal management system for performing thermal management of a vehicle using a thermal medium includes a first flow path not provided with a reserve tank, a second flow path provided with a reserve tank, a switching device configured to be switchable between connection and disconnection of the first and second flow paths, and a control device for controlling the switching device. The control device executes connection control when at least one of preset one or more trigger conditions is satisfied and a predetermined circumstance is satisfied. The one or more trigger conditions include at least one of: an instruction regarding the exchange of the thermal medium is transmitted from an external tool to the control device; a restart of the control device after the auxiliary battery is removed from the vehicle; and an integrated value of the trip number of the vehicle has reached the predetermined value.

### CROSS-REFERENCE TO RELATED APPLICATION

This application claims priority to Japanese Patent Application No. 2024-045044 filed on Mar. 21, 2024, incorporated herein by reference in its entirety.

### BACKGROUND

### 1. Technical Field

The present disclosure relates to a thermal management system.

### 2. Description of Related Art

Japanese Unexamined Patent Application Publication No. 2023-063735 (JP 2023-063735 A) discloses a temperature control system that includes a coolant circuit. First to fifth paths through which a coolant flows, a five-way valve, and a reserve tank are provided in the coolant circuit. Each of the first to fifth paths has one end connected to the five-way valve and the other end connected to the reserve tank.

### SUMMARY

In the system described in JP 2023-063735 A, for example, all of the first to fifth paths, through which a thermal medium such as the coolant flows, are connected to the reserve tank. However, depending on the structure of a vehicle, it may be difficult to connect all of the paths (flow paths), which can be connected by a switching device (for example, the five-way valve), to the reserve tank. In the thermal management system of a vehicle, a plurality of flow paths that can be connected by the switching device may include a flow path that is separated from the reserve tank. However, in the flow path separated from the reserve tank, air (air bubbles) are easily generated and/or easily remain within the thermal medium flowing through the separated flow path. Deterioration and/or over rotation of a pump that circulates the thermal medium is accelerated as the amount of air bubbles within the thermal medium increases.

An objective of the present disclosure is to provide a thermal management system in which a thermal medium can flow through a flow path separated from a reserve tank, as necessary, while reducing an amount of air bubbles within the thermal medium.

A thermal management system relating to the present disclosure is configured to perform thermal management of a vehicle.
The thermal management system includes
a first flow path in which a reserve tank is not provided,
a second flow path in which the reserve tank is provided,
a switching device configured to be switchable between connection and separation of the first flow path and the second flow path, and
a control device that controls the switching device.
The control device is configured to execute a connection control to cause a thermal medium to flow through the first flow path and the second flow path connected by the switching device when a predetermined circumstance is satisfied when at least one of one or more preset trigger conditions is established.
The one or more trigger conditions includes at least one of:
an instruction related to an exchange of the thermal medium has been transmitted to the control device from an external tool connected to the vehicle (first trigger condition),
the control device has restarted after an auxiliary battery is removed from the vehicle (second trigger condition), and
an integrated value of a trip number of the vehicle integrated under a predetermined condition has reached a predetermined value (third trigger condition).

In the configuration, the first flow path and the second flow path can be separated by the switching device. In this way, thermal management of the vehicle can be performed separately for the first flow path and the second flow path. However, air bubbles may be generated in the thermal medium within the first flow path separated from the reserve tank. Accordingly, the control device executes a control (connection control) to cause the thermal medium to flow through the connected first flow path and second flow path. Air bleeding of the thermal medium within the first flow path is performed by having the first flow path connected to the second flow path in which the reserve tank is provided. Moreover, each of the first to third trigger conditions is easily established at a timing when an amount of air bubbles within the thermal medium increases to an extent that air bleeding becomes necessary. A connection control (air bleeding) becomes easy at an appropriate timing by having at least one of the first to third trigger conditions set.

According to the present disclosure, a thermal management system can be provided in which a thermal medium can flow through a flow path separated from a reserve tank, as necessary, while reducing an amount of air bubbles within the thermal medium.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a thermal management circuit of a thermal management system according to an embodiment of the present disclosure;

FIG. 2 is a diagram illustrating a vehicle to which the thermal management system according to the present embodiment is applied;

FIG. 3 is a diagram illustrating a configuration of a control device of the thermal management system according to the present embodiment;

FIG. 4 is a diagram for describing the control related to the thermal management of the present embodiment;

FIG. 5 is a flow chart showing a process related to parameter setting of the present embodiment; and

FIG. 6 is a diagram for explaining an operation of the thermal management system according to the present embodiment.

### DETAILED DESCRIPTION OF EMBODIMENTS

Embodiments of the present disclosure will be described in detail with reference to the drawings. The same or corresponding parts in the drawings are designated by the same reference signs and repetitive description will be omitted.

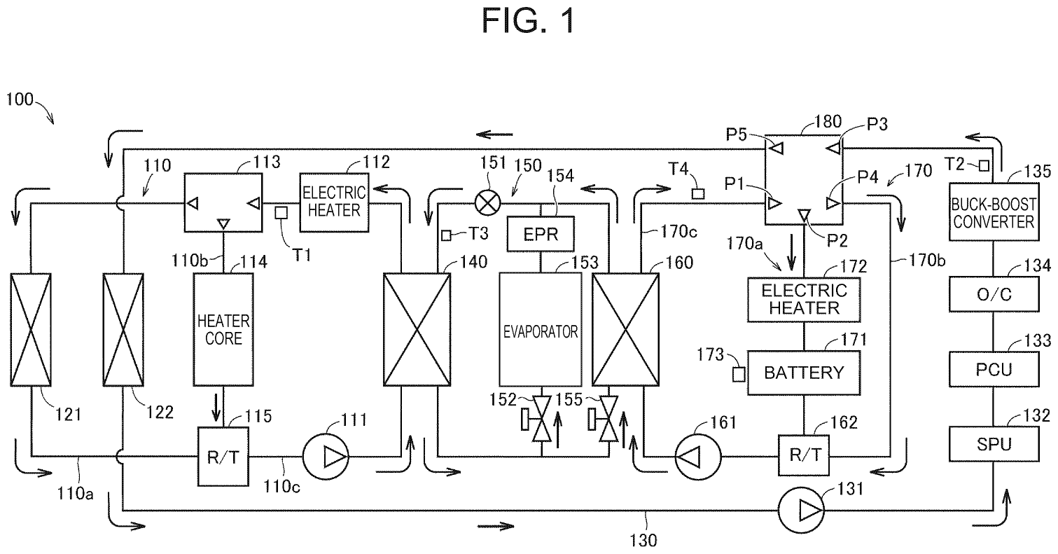

The thermal management system according to this embodiment includes the thermal management circuit 100 shown in FIG. 1. FIG. 1 is a diagram illustrating a configuration of a thermal management circuit 100. The thermal management circuit 100 includes a high-temperature flow path 110, a low-temperature flow path 130, a condenser 140, a refrigeration cycle flow path 150, a chiller 160, a battery flow path 170, and a five-way valve 180. The five-way valve 180 comprises P5 from five-port P1. The five-way valve 180 is configured to be switchable between connection (communication) and disconnection (non-communication) of the low-temperature flow path 130 and the battery flow path 170. The low-temperature flow path 130 is not provided with a reserve tank (R/T). A reserve tank 162 is provided in the battery flow path 170. The five-way valve 180 is controlled by an ECU 500. Each of the five-way valve 180, the low-temperature flow path 130, the battery flow path 170, and ECU 500 corresponds to an exemplary “switching device”, “first flow path”, “second flow path”, and “control device”.

The high-temperature flow path 110 includes flow paths 110a, 110b, 110c. The high-temperature flow path 110 is provided with a three-way valve 113 and a reserve tank 115. One end of each of the flow paths 110a, 110b, 110c is connected to the three-way valve 113, and the other end thereof is connected to the reserve tank 115. A high-temperature (HT) radiator 121 is provided in the flow path 110a. The flow path 110b is provided with a heater-core 114. The flow path 110c is provided with pumps 111, electric heaters 112, and capacitors 140. The high-temperature flow path 110 and the refrigeration cycle flow path 150 are connected to each other via a condenser 140 so as to be able to exchange heat. The refrigeration cycle flow path 150 is provided with a compressor 151, an expansion valve 152, an evaporator 153, a EPR (evaporative pressure-regulating valve) 154, and an expansion valve 155.

The high-temperature flow path 110 and the low-temperature flow path 130 are heat-exchangeably connected to each other via a low-temperature (LT) radiator 122. One end of the low-temperature flow path 130 is connected to the port P3 of the five-way valve 180, and the other end of the low-temperature flow path 130 is connected to the port P5 of the five-way valve 180. The low-temperature flow path 130 is provided with a pump 131, a Smart Power Unit (SPU) 132, a Power Control Unit (PCU) 133, an oil cooler (O/C) 134, and a step-up/step-down converter 135.

The refrigeration cycle flow path 150 and the battery flow path 170 are connected to each other via a chiller 160 so as to be able to exchange heat therebetween. The battery flow path 170 includes flow paths 170a, 170b, 170c. One end of each of the flow paths 170a, 170b, 170c is connected to the five-way valve 180, and the other end thereof is connected to the reserve tank 162. Specifically, one end of the flow paths 170a, 170b, 170c is connected to ports P2, P4, P1 of each of the five-way valves 180. A battery 171 and electric heater 172 are provided in the flow path 170a. The electric heater 172 heats at least one of the thermal medium in the flow path 170a and the battery 171. A pump 161 is provided in the flow path 170c. The flow path 170a is a cooling path through which the battery 171 can be cooled by the thermal medium. The flow path 170b is a bypass path that bypasses the battery 171 and is provided so as to bypass the flow path 170a. The five-way valve 180 is configured to be capable of switching between the flow path 170a and the flow path 170b.

The first thermal medium flows through the high-temperature flow path 110. The second thermal medium flows through the refrigeration cycle flow path 150. A third thermal medium flows through each of the low-temperature flow path 130 and the battery flow path 170. In this embodiment, the same type of thermal medium (third thermal medium) as the thermal medium flowing through the low-temperature flow path 130 flows through the battery flow path 170. As each of the first to third heat media, a known thermal medium can be employed. Examples of the second thermal medium include a chlorofluorocarbon refrigerant, carbon dioxide, and propane gas. In this embodiment, a liquid thermal medium (for example, water or a cooling liquid other than water) is employed as each of the first thermal medium and the third thermal medium. Exemplary cooling liquids other than water include insulating oils or antifreeze liquids such as Long Life Coolant (LLC). In this embodiment, each of the pumps 111, 131, 161 is a water pump (W/P).

Flow path sensors T1, T2, T3, T4 are provided in the high-temperature flow path 110, the low-temperature flow path 130, the refrigeration cycle flow path 150, and the battery flow path 170, respectively. Each of the flow path sensors T1 to T4 includes a temperature sensor that detects the temperature of the thermal medium in the corresponding flow path, and a flow rate sensor that measures the flow rate of the thermal medium flowing through the corresponding flow path. The battery 171 is also provided with a Battery Management System (BMS) 173 for monitoring the status of the battery 171. BMS 173 includes various sensors that detect the status (e.g., voltage, current, and temperature) of the battery 171, and outputs the detected data to ECU 500.

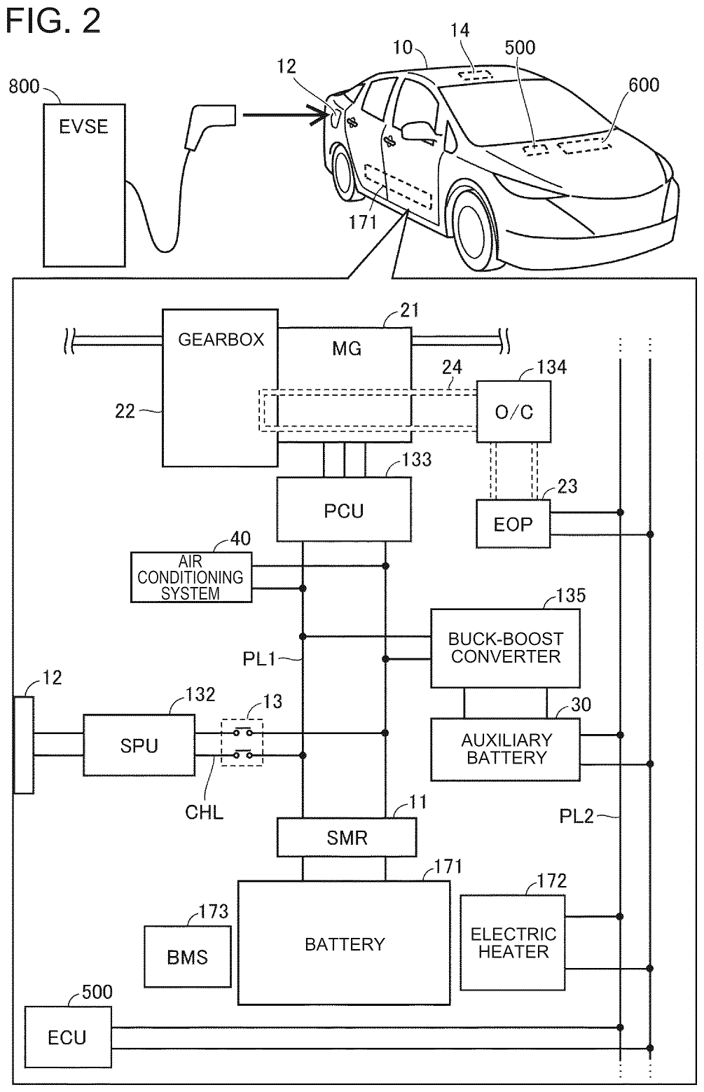

FIG. 2 is a diagram illustrating an example of a configuration of a vehicle equipped with the thermal management system according to the embodiment. Referring to FIG. 2, the vehicle 10 is an electrified vehicle equipped with the above-described thermal management circuit 100. The vehicle 10 is configured to be able to travel using electric power output from the battery 171 (driving battery). The battery 171 may include a secondary battery such as a lithium-ion battery. The type of the secondary battery may be a liquid secondary battery or an all-solid secondary battery. A plurality of secondary batteries may form a battery pack. Instead of the secondary battery, another power storage device (for example, an electric double layer capacitor) may be employed. The vehicle 10 is, for example, battery electric vehicle (BEV) without internal combustion engines. However, the present disclosure is not limited thereto, and the vehicle 10 may be plug-in hybrid electric vehicle (PHEV) equipped with an internal combustion engine, or may be other electrified vehicle (xEV).

Vehicle 10 further includes System Main Relay (SMR) 11, inlet 12, charging relay 13, communication device 14, Motor Generator (MG) 21, gearbox 22, electric oil pump (EOP) 23, oil circuit 24, auxiliary battery 30, air conditioner 40, Electronic Control Unit (ECU) 500, and Human Machine Interface (HMI) 600. The voltage of the battery 171 is higher than the voltage of the auxiliary battery 30. The battery 171 applies a voltage to the high-voltage power supply line PL1. The auxiliary battery 30 applies a voltage to the low-voltage power supply line PL2. The air conditioner 40 is connected to the high-voltage power supply line PL1. For example, the heating circuit of the air conditioner 40 constitutes the high-temperature flow path 110 (FIG. 1), and the cooling circuit of the air conditioner 40 constitutes the refrigeration cycle flow path 150 (FIG. 1). The step-up/step-down converter 135 is connected to the high-voltage power supply line PL1 and transforms DC power between the battery 171 and the auxiliary battery 30. The auxiliary battery 30 supplies electric power to in-vehicle devices (pumps, compressors, heaters, valves, ECU 500, and the like) connected to the low-voltage power supply line PL2. SMR 11, the charging relay 13, EOP 23, the air conditioner 40, PCU 133, the step-up/step-down converter 135, and the electric heater 172 are controlled by a ECU 500.

SMR 11 is a relay located between the battery 171 and PCU 133. MG 21 functions as a driving motor and rotates the drive wheels of the vehicle 10. PCU 133 is connected to the high-voltage power supply line PL1 and drives MG 21 by using electric power supplied from the battery 171. PCU 133 includes inverters, for example. MG 21 converts power into torques. This torque is transmitted to the drive wheels of the vehicle 10 via the gear box 22. In addition, MG 21 performs regenerative power generation, for example, at the time of deceleration of the vehicle 10, and charges the battery 171.

EOP 23 circulates lubricating oil to the oil circuit 24. The oil cooler 134 cools the lubricating oil in the oil circuit 24 by using the thermal medium flowing through the low-temperature flow path 130 (FIG. 1). The oil circuit 24 cools MG 21 and gearbox 22 with lubricating oil.

The vehicle 10 is configured to be capable of performing external charging (charging of the battery 171 by electric power from the outside of the vehicle). SPU 132 is provided in the charging line CHL and functions as an in-vehicle charger (charging circuit). SPU 132 may function as Electric Supply Unit (ESU). The charging relay 13 switches between connecting and disconnecting the charging line CHL. ECU 500 connects the charging relay 13 prior to starting the external charging and controls SPU 132 during the charging. When the connector of the charging cable connected to the vehicle power supply facility (EVSE) 800 is connected to the inlet 12 of the parked vehicle 10 (plug-in), the vehicle 10 is electrically connected to EVSE 800. The vehicle 10 can charge the battery 171 using the electric power inputted from EVSE 800 to the inlet 12. One end of the charging line CHL is connected between SMR 11 and PCU 133, and the other end thereof is connected to the inlet 12. However, the present disclosure is not limited thereto, and one end of the charging line CHL may be connected between the battery 171 and SMR 11.

HMI 600 is an HMI (in-vehicle HMI) mounted on the vehicle 10, and includes an inputting device and a notification device. HMI 600 may include at least one of a meter panel, a navigation system, a center display, and a head-up display.

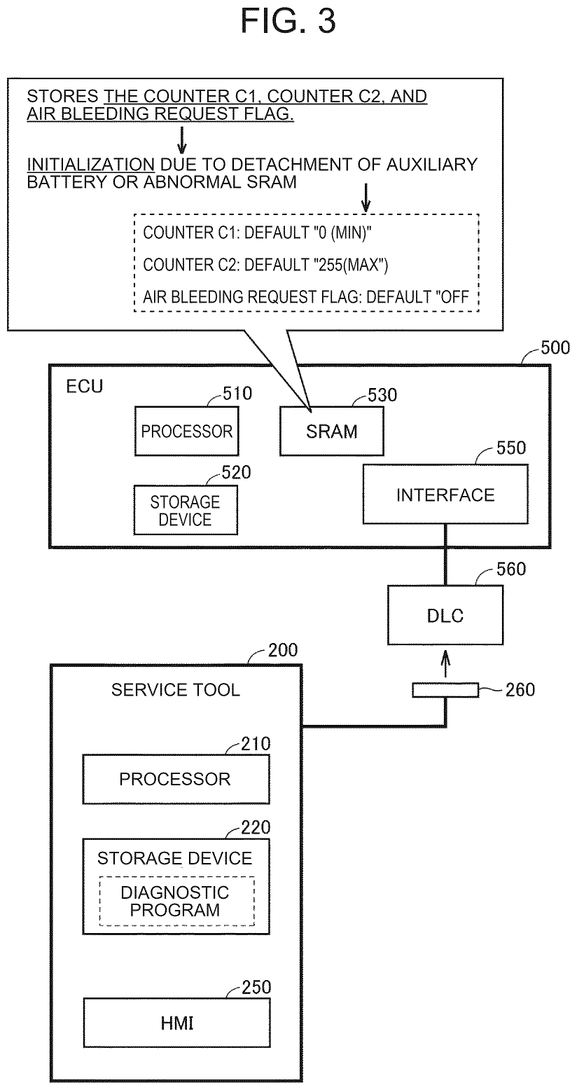

FIG. 3 is a diagram illustrating a configuration of a ECU 500. Referring to FIG. 3, ECU 500 includes a processor 510 such as a Central Processing Unit (CPU), a storage device 520, and a Static Random Access Memory (SRAM) 530. The storage device 520 includes, for example, a non-volatile memory, and is configured to store stored information. The storage device 520 stores a program. In this embodiment, the processor 510 executes a program to execute various kinds of control. However, various kinds of control may be executed by hardware (electronic circuit). SRAM 530 is a volatile memory and stores various parameters (for example, a counter C1, a counter C2, and an air bleeding request flag) used in the program. ECU 500 also has a timer function (timer). The timing function may be realized by hardware (timer circuit) or by software.

The service tool (hereinafter, simply referred to as “tool”) 200 includes a computer including a processor 210 and a storage device 220. The tool 200 further includes an HMI 250. HMI 250 may include a touch panel display. The tool 200 corresponds to an example of an “external tool” according to the present disclosure.

ECU 500 further comprises an interface 550 of Data Link Connector (DLC) 560. DLC 560 is a connector connectable to the connector 260 of the tool 200, and is disposed around the driver's seat of the vehicle 10, for example. DLC 560 may be a terminal of a DLC 3 corresponding to Controller Area Network (CAN) communication. A diagnostic program is stored in the storage device 220 of the tool 200, and the tool 200 can read the data of the vehicle 10 stored in the storage device 520 by connecting the connector 260 of the tool 200 to DLC 560. For example, a tool 200 is connected to the vehicle 10 in a dealer or a factory, and a diagnosis of the vehicle 10 is performed. Dealers are stores that sell vehicles manufactured by automobile manufacturers and provide after-sales services (inspection, maintenance, etc.).

The value of the parameter stored in SRAM 530 is initialized when the power of ECU 500 is turned off, and becomes a preset initial value. The initial values of the counter C1, the counter C2, and the air bleeding request flag are “0 (minimum value)”, “255 (maximum value)”, and “OFF”, respectively.

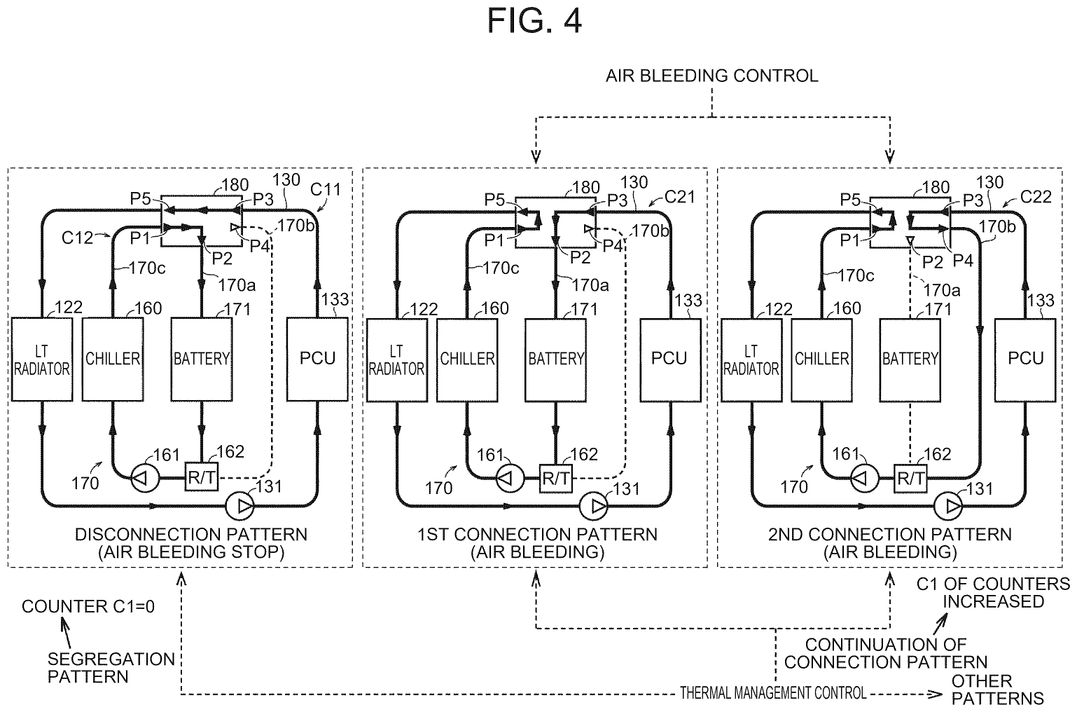

In this embodiment, the thermal management system performs thermal management of the vehicle 10 using the thermal medium. ECU 500 performs air bleeding control (special thermal management control) in addition to normal thermal management control (hereinafter, simply referred to as “thermal management control”). The thermal management circuit 100 may be controlled, for example, to the decoupling pattern, the first coupling pattern, and the second coupling pattern shown in FIG. 4. FIG. 4 is a diagram for explaining the thermal management control and the air bleeding control.

In the decoupling pattern, in the five-way valve 180, the ports P1 and P2 are connected and the ports P3 and P5 are connected. The port P4 is not connected to any other port. As a result, the circuits C11 and C12 which are separated from each other are formed. In the circuit C11, the port P5, the low-temperature flow path 130, and the port P3 are connected in series. In the circuit C12, the port P2, the flow path 170a, the reserve tank 162, the flow path 170c, and the port P1 are connected in series. In the decoupling pattern, the circuit C11 (including the low-temperature flow path 130) is decoupled from the reserve tank. Therefore, air bleeding of the third thermal medium in the low-temperature flow path 130 is not performed.

On the other hand, in the first connection pattern, in the five-way valve 180, the ports P1 and P5 are connected, and the port P2 and P3 are connected. The port P4 is not connected to any other port. As a result, a circuit C21 is formed. In the circuit C21, the port P5, the low-temperature flow path 130, the port P3, the port P2, the flow path 170a, the reserve tank 162, the flow path 170c, and the port P1 are connected in series. Further, in the second connection pattern, in the five-way valve 180, the ports P1 and P5 are connected, and the ports P3 and P4 are connected. The port P2 is not connected to any other port. As a result, a circuit C22 is formed. In the circuit C22, the port P5, the low-temperature flow path 130, the port P3, the port P4, the flow path 170b, the reserve tank 162, the flow path 170c, and the port P1 are connected in series. In each of the first and second connection patterns, the battery flow path 170 and the low-temperature flow path 130 are connected by the five-way valve 180. By connecting the low-temperature flow path 130 to the battery flow path 170 in which the reserve tank 162 is provided, air bleeding of the third thermal medium in the low-temperature flow path 130 is performed.

The air bleeding control is a control for causing the thermal medium to flow through the low-temperature flow path 130 and the battery flow path 170 connected by the five-way valve 180 (switching device). Specifically, ECU 500 performs air bleeding control by driving at least one of the pumps 131 and 161 with the thermal management circuit 100 in the first or second connection pattern described above. ECU 500 obtains the temperature of the thermal medium in the low-temperature flow path 130 based on the power of the flow path sensor T2 (FIG. 1). ECU 500 may execute the air bleeding control in the first connection pattern when the temperature of the thermal medium is lower than a predetermined reference value, and in the second connection pattern when the temperature of the thermal medium is higher than the reference value. According to such control, the air bleeding of the third thermal medium is performed while the temperature rise of the battery 171 is suppressed. The air bleeding control according to this embodiment corresponds to an example of “connection control”.

In the thermal management control, ECU 500 performs thermal management of the vehicle 10 with the thermal management circuit 100 in any pattern. ECU 500 may perform the thermal management of the vehicle 10 in any of the above-described disconnection pattern, the first connection pattern, and the second connection pattern, or may perform the thermal management of the vehicle 10 in another pattern. In the thermal management control, ECU 500 may choose an optimal pattern for air conditioning in the vehicle cabin and/or for temperature-regulating the battery 171 based on the conditions of the user and the condition of the vehicle 10. For example, ECU 500 may choose a decoupling pattern to cool the battery 171. ECU 500 may also select the first or second connection patterns for air conditioning (e.g., heat pumps).

ECU 500 updates the counter C1 during the performance of the thermal management control. The counter C1 indicates a period during which the low-temperature flow path 130 and the battery flow path 170 are maintained in a connected state (for example, the first connection pattern or the second connection pattern). In the thermal management control, ECU 500 increments the counter C1 in accordance with the elapsed time while the connection between the low-temperature flow path 130 and the battery flow path 170 continues. When the low-temperature flow path 130 and the battery flow path 170 are disconnected, ECU 500 returns the counter C1 to the default value (0).

When at least one of the first to third trigger conditions is satisfied, if a predetermined condition (hereinafter referred to as “air bleeding condition”) is satisfied, ECU 500 executes the air bleeding control. The first trigger condition is that an instruction to replace the thermal medium is sent to ECU 500 from an external tool connected to the vehicle 10. The second trigger condition is that ECU 500 is restarted after the auxiliary battery 30 is removed from the vehicle 10. The third trigger condition is that the integrated value of the trip number of the vehicle 10 integrated under the condition that the time period during which the low-temperature flow path 130 and the battery flow path 170 are maintained in the connected state has not reached the predetermined time has reached the predetermined value.

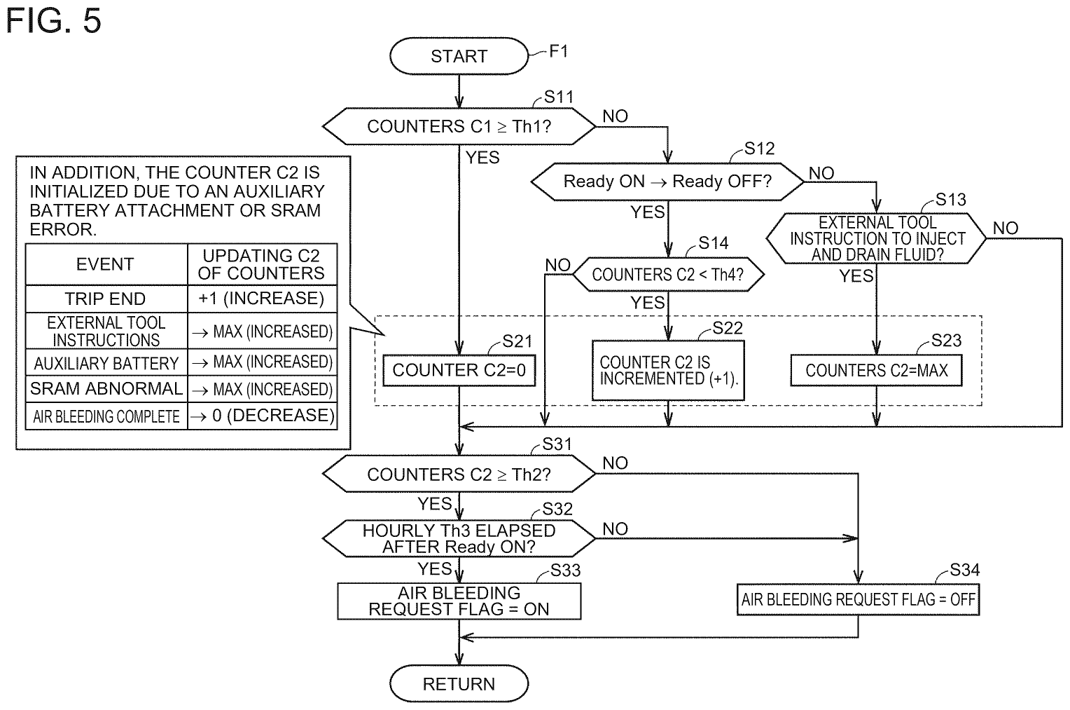

ECU 500 determines the success or failure of each of the first to third trigger conditions and the air bleeding condition using the counters C1, C2 and the air bleeding request flag. FIG. 5 is a flow chart illustrating a process of setting the counter C2 and the air bleeding request flag. “S” in the flowchart means step. The process flow F1 is repeatedly executed by ECU 500.

Referring to FIG. 5, in S11, ECU 500 determines whether or not C1 of counter updated in the above-described manner is greater than or equal to a predetermined value (hereinafter, referred to as “Th1”). In one instance, Th1 is 60 seconds. When the counter C1 is equal to or larger than Th1 value (YES in S11), ECU 500 sets “0” in the counter C2 in S21, and then advances the process to S31.

If counter C1 is less than Th1 (NO in S11), ECU 500 determines, at S12, whether the state of the vehicle 10 has switched from Ready-ON state to Ready-OFF state. In Ready-ON condition, the vehicle drive devices (PCU 133 and MG 21) that use power to rotate the drive wheels of the vehicle 10 are activated. In Ready-OFF state, the vehicle drive device is in a stopped state (inactive state). In this embodiment, power is supplied to the vehicle drive device when SMR 11 is connected. When the charging relay 13 is in the shut-off state, the vehicle drive device is in the operating state. However, when the charging relay 13 is in the connected state, the vehicle drive device is in the stopped state, and the traveling of the vehicle 10 is prohibited. When the control system (vehicle system) of the vehicle 10 is stopped, each of the charging relay 13 and SMR 11 is shut off. After the vehicle system (including ECU 500) is activated, HMI 600 receives a trip-start instruction. Then, when HMI 600 receives a trip starting instruction from the user, ECU 500 switches the state of the vehicle 10 from Ready-OFF state to Ready-ON state. As a result, a new trip is started, and HMI 600 receives the trip termination instruction. Thereafter, when HMI 600 receives the trip termination instruction, ECU 500 turns Ready-OFF the vehicle 10. As a result, the trip ends, S12 determines that the trip is YES, and the process proceeds to S14. When the trip ends, HMI 600 receives the trip starting instruction again.

In S14, ECU 500 determines whether the counter C2 is less than a predetermined value (hereinafter, referred to as “Th4”). In this embodiment, Th4 is greater than Th2 described below and less than the maximal value “255” (the first value and the second value). In one instance, Th4 is 240. If the counter C2 is less than Th4 (YES in S14), ECU 500 increments the counter C2 by “+1” in S22. In this way, the trip number of the vehicle 10 is integrated. The counter C2 indicates an integrated value of the trip number. Thereafter, the process proceeds to S31. On the other hand, when counter C2 is equal to or larger than Th4 (NO in S14), the process skips S22 and proceeds to S31.

If it is not detected that the state has been switched from Ready-ON state to Ready-OFF state (NO in S12), ECU 500 determines, at S13, whether or not an instruction regarding the replacement of the thermal medium has been received from an external tool (for example, the tool 200) connected to the vehicle 10. For example, the third thermal medium may be exchanged by the dealer at a timing when a predetermined time (for example, about 15 years) has elapsed from the initial state (new vehicle). The operator exchanging the thermal medium may connect the tool 200 to DLC 560 of the vehicle 10 and control the thermal management circuit 100 using the tool 200. For example, after the tool 200 has opened all of the valves of the five-way valve 180 (a pattern not used in normal thermal management control) and the operator removes the used third thermal medium from the vehicle 10 and injects the new third thermal medium into the vehicle 10, the tool 200 causes the thermal management circuit 100 to be in the first or second connection pattern to drive at least one of the pumps 131 and 161, thereby exchanging the thermal medium. Fine air remains in the new third thermal medium that has been injected, and the new third thermal medium tends to collect and become lumps during traveling of the vehicle 10.

At the time of exchanging the thermal medium, an instruction regarding the pouring and draining is sent from the tool 200 to ECU 500. When this instruction is received (YES in S13), ECU 500 sets “255 (max.)” in the counter C2 in S23, and then advances the process to S31. However, while the communication between ECU 500 and the tool 200 continues, the control by the tool 200 is preferentially executed, and the process flow F1 is stopped. ECU 500 may determine whether communication is ongoing based on the presence or absence of an answerback from the tool 200. On the other hand, if the external tooling is not used to replace the thermal medium, i.e., ECU 500 does not receive an instruction regarding pouring and draining (NO in S13), the process skips S23 and proceeds to S31.

As described above, the counter C2 (parameter) is updated. Specifically, the value of the counter C2 is updated by ECU 500 being S22 each time the trip number of the vehicle 10 increases under the condition that the value of the counter C1 has not reached Th1 (NO in S11). The counter C1 is a period during which the low-temperature flow path 130 and the battery flow path 170 are maintained connected to each other. When the value of the counter C1 reaches Th1 (YES in S11), ECU 500 sets the value of the counter C2 to “0” in S21. When ECU 500 receives an instruction to replace the thermal medium from an external tool connected to the vehicle 10 (YES in S13), ECU 500 sets the value of the counter C2 to the highest value (first value) in S23.

Further, when the power of ECU 500 is turned off due to the detachment of the auxiliary battery 30 from the vehicle 10 (the disconnection of the terminal), and then ECU 500 is restarted, the counter C2 is initialized, and the value of the counter C2 becomes the largest value (the second value). Also, when an error (for example, a failure) occurs in SRAM 530, the counter C2 is initialized, and the value of the counter C2 becomes the largest value (the second value). In this embodiment, the first value and the second value are the same value. However, the present disclosure is not limited thereto, and the first value and the second value may be set to different values.

In this embodiment, each of the plurality of events (trip termination, external tooling instructions, auxiliary battery attachment/detachment, SRAM error, air bleeding completion, etc.) is pre-assigned a predetermined increment or a predetermined decrement of the counter C2. When any of the plurality of events occurs, counter C2 allocated to the event is increased or decreased.

In S31, ECU 500 determines whether the counter C2 is greater than or equal to a predetermined value (hereinafter, referred to as “Th2”). In one instance, Th2 is 40. When the counter C2 is equal to or larger than Th2 value (YES in S31), the process proceeds to S32. In S32, ECU 500 determines whether a predetermined time (hereinafter, referred to as “time Th3”) has elapsed since Ready-ON of the vehicle 10. In one instance, the temporal Th3 is 60 seconds. When the time Th3 has elapsed since Ready-ON of the vehicle 10 (YES in S32), ECU 500 sets the air bleeding request flag to “ON” in S33.

If the counter C2 is less than Th2, S31 determines NO, and the process proceeds to S34. Further, when the time Th3 has not elapsed since the vehicle 10 is in Ready-ON state, or when the vehicle 10 is in Ready-OFF state, it is determined as NO by S32, and the process proceeds to S34. In S34, ECU 500 sets the air bleeding demand flag to “OFF”. When the air bleeding request flag is set in S33 or S34, the process returns to the first step (S11).

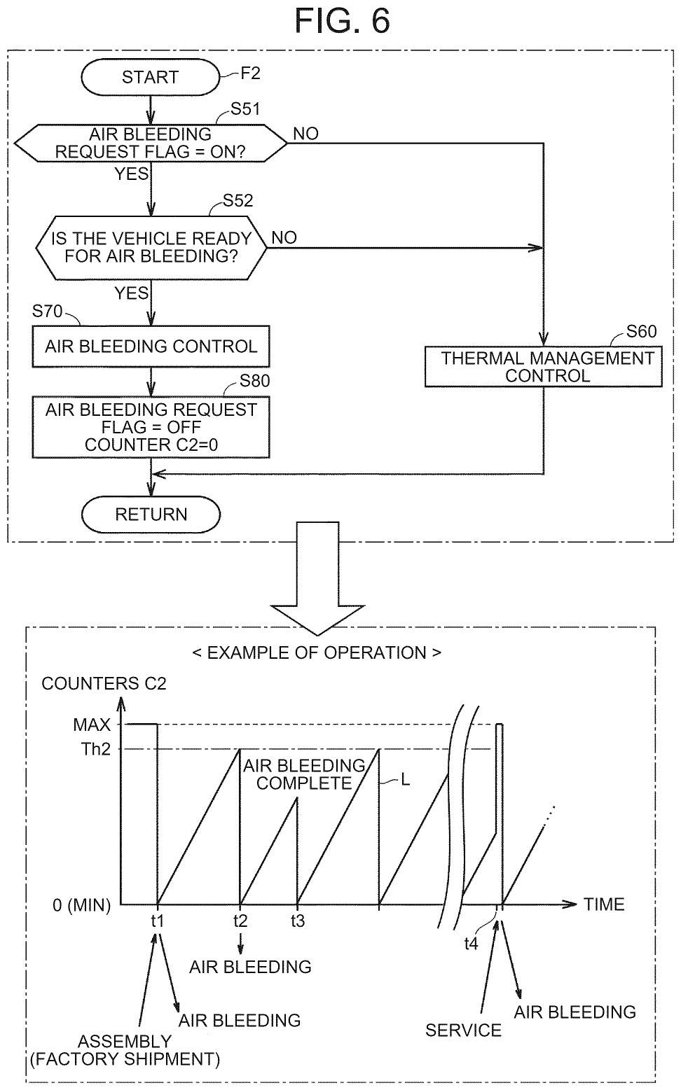

FIG. 6 is a diagram for explaining an operation of the thermal management system. ECU 500 is executed by selecting one of the thermal management control and the air bleeding control according to the process flow F2 illustrated in FIG. 6. In this embodiment, HMI 600 receives a system start instruction and a system stop instruction. When HMI 600 receives a system start instruction from the user when the vehicle system is stopped, ECU 500 starts and starts each of the process flows F1, F2. Process flows F1 and F2 are performed in parallel while ECU 500 is active.

In the process flow F2, it is determined whether ECU 500 is S51 and the air bleeding request flag is “ON”. When the air bleeding request flag is “ON” (YES in S51), ECU 500 determines, in S52, whether the vehicle 10 is capable of air bleeding. ECU 500 may determine whether the vehicle 10 is in an air bleeding state based on at least one of the traveling state of the vehicle 10, the air-conditioning state of the vehicle 10, and the state of the battery 171. For example, ECU 500 may determine that the vehicle 10 is capable of air bleeding when the vehicle 10 is in steady running or stopping, the air conditioner 40 is in steady running or stopping, and the temperature of the battery 171 is within a predetermined range (recommended temperature range). ECU 500 may determine that the vehicle 10 is not in an air bleeding condition when the vehicle 10 is in transient travel (for example, during acceleration or deceleration), when the air conditioner 40 is in transient operation, or when the temperature of the battery 171 is out of the predetermined range.

When the vehicle 10 is ready for air bleeding (YES in S52), ECU 500 executes the above-described air bleeding control (see FIG. 4) in S70. ECU 500 controls the thermal management circuit 100 (including the five-way valve 180) such that the air bleeding control is continuously performed until the air bleeding of the third thermal medium flowing through the low-temperature flow path 130 and the battery flow path 170 is completed. ECU 500 may determine that the air bleeding of the thermal medium is completed when a predetermined time (hereinafter, referred to as “air bleeding time”) has elapsed since the air bleeding control is started. The air bleeding time may be variable. ECU 500 may determine the air bleeding period based on the counter C2. In this embodiment, an upper limit guard (Th4 in S14 of FIG. 5) lower than the maxima (255) is provided for the third trigger condition. Therefore, ECU 500 can identify the air bleeding control based on the third trigger condition and the air bleeding control based on the other trigger condition based on the counter C2. ECU 500 may change the air bleeding period between the air bleeding control based on the third trigger condition and the air bleeding control based on another trigger condition. ECU 500 may increase the air bleeding period as the counter C2 increases. The amount of air bubbles in the thermal medium tends to increase during travel of the vehicle 10. For example, fine bubbles may be generated in the thermal medium due to a liquid level swing of the reserve tank when the vehicle 10 travels on a rough road surface or the like. However, the air bleeding time may be a fixed value. Further, the method of determining the completion of the air bleeding is not limited to the above. For example, ECU 500 may determine whether the air bleeding is completed based on the condition of the thermal medium.

When the air bleeding of the third thermal medium is completed, the process proceeds to S80. In S80, ECU 500 sets the air bleeding request flag to “OFF” and the counter C2 to “0 (min)”. The process then returns to the first step (S51). However, when a predetermined stop condition is satisfied during execution of the air bleeding control, the air bleeding control may be stopped before the air bleeding is completed. In addition, when the air bleeding control is stopped, S80 process may not be executed, and after the reason for the stop is resolved, the air bleeding control may be resumed by S70.

If the vehicle 10 is not air bleeding (NO in S52), the process proceeds to S60. Also, when the air bleeding request flag is “OFF” (NO in S51), the process proceeds to S60. In S60, ECU 500 performs the thermal management control described above (see FIG. 4). Thereafter, the process returns to S51. While the air bleeding request flag is “OFF”, or while the vehicle 10 is not in the air bleeding condition, thermal management control (S60) is continuously performed.

A line L in FIG. 6 shows an exemplary transition of the counter C2 when the process flows F1 and F2 (see FIGS. 5 and 6) are repeatedly executed by ECU 500. “t” in the time chart means timing. t1 corresponds to the timing at which the assembly of the vehicle 10 is completed (at the time of shipping from the factory).

Since the counter C2 is initialized when ECU 500 is started, in t1, it is determined as YES in S31 of FIG. 5. Therefore, the air bleeding control is executed by satisfying the air bleeding condition. Air bleeding condition in this embodiment are met when both S32 of FIGS. 5 and S52 of FIG. 6 are determined to be YES. When the vehicle 10 is in Ready-ON state at the time of shipping from the factory, and the vehicle 10 is in the air bleeding state when the time Th3 has elapsed, the air bleeding control is executed.

Further, after the vehicle 10 is shipped, the third trigger condition is satisfied by t2, and the air bleeding condition is satisfied, so that the air bleeding control is executed. ECU 500 integrates the trip number of the vehicle 10 under the condition that the value of the counter C1 does not reach Th1, and executes the air bleeding control when the integrated value of the trip number reaches a predetermined value (Th2). It is considered that the larger the integrated value of the trip number integrated under such conditions, the larger the amount of bubbles in the thermal medium. According to the third trigger condition, the air bleeding control is easily executed at an appropriate timing.

The air bleeding in this embodiment includes that a predetermined time of time has elapsed since the vehicle drive device was activated (S32 in FIG. 5). As a result, the air bleeding control is easily executed in the vehicle 10 in the steady state. For example, immediately after the vehicle system is activated, the vehicle 10 tends to be in a predetermined initial state (default). If sufficient time has elapsed since the vehicle drive device is activated, it is less susceptible to such an initial setting. Further, since the vehicle drive device is stopped (inactive) during the external charging, the air bleeding control is not executed during the external charging. During external charging, the state of the battery 171 becomes unstable. Therefore, ECU 500 prioritizes the thermal management control of the battery 171 over the air bleeding during the external charge.

Thereafter, in t3, the value of the counter C1 reaches Th1, and the value of the counter C2 becomes “0” (S21 in FIG. 5). The fact that the counter C1 reaches Th1 means that the air bleeding is completed during the thermal management control (S60). When the low-temperature flow path 130 and the battery flow path 170 are continuously maintained in a connected state for a sufficiently long time, air bleeding of the thermal medium is performed in the period. As a result, the amount of bubbles in the thermal medium is sufficiently reduced.

Thereafter, in t4, the vehicle 10 receives after-sales service at the dealer. At this time, when the thermal medium is exchanged using the external tool, the air bleeding control based on the first trigger condition (S13, S23 in FIG. 5) is executed. Alternatively, when the auxiliary battery 30 is attached and detached for maintenance, air bleeding control based on the second trigger condition (see FIG. 3 and FIG. 5) is executed.

As described above, according to the thermal management system of this embodiment, the thermal medium can be caused to flow in the flow path separated from the reserve tank as necessary while reducing the amount of bubbles in the thermal medium. In the above-described embodiment, three trigger conditions (first to third trigger conditions) are set, but only any one or two of the first to third trigger conditions may be set. Further, the air bleeding condition includes that a predetermined time has elapsed since the vehicle drive device is in the operating state (first condition) and that the vehicle is in the air bleeding state (second condition). However, the present disclosure is not limited thereto, and one of the first condition and the second condition may be excluded, or other conditions may be added instead of at least one of the first condition and the second condition. In the above-described embodiment, the in-vehicle HMI is adopted as the user terminal. However, the present disclosure is not limited thereto, and a mobile terminal that can be carried by a user may be employed as the user terminal.

The configuration of the vehicle is not limited to the configuration illustrated in FIG. 1 to FIG. 3. For example, instead of the five-way valve 180, other multi-way valves (e.g., a six-way valve, a seven-way valve, an eight-way valve, a nine-way valve, or a ten-way valve) may be employed as the switching device. Further, the switching device may be configured by a plurality of multi-way valves.

The vehicle is not limited to a passenger car, and may be a bus, a truck, or a work vehicle (a tractor, a forklift, or the like). The vehicle may be configured to be able to travel unmanned by automatic driving or remote driving. The vehicles may be automated guided vehicles (AGV). The number of wheels is not limited to four, and may be three or five or more wheels. The vehicle may be configured to be wirelessly chargeable.

The embodiments disclosed herein are to be considered in all respects as illustrative and not restrictive. It is intended that the scope of the disclosure be defined by the appended claims rather than the description of the embodiments described above, and that all changes within the meaning and range of equivalency of the claims be embraced therein.

What is claimed is:

1. A thermal management system that performs thermal management of a vehicle, the thermal management system comprising:
a first flow path in which a reserve tank is not provided;
a second flow path in which the reserve tank is provided;
a switching device configured to be switchable between connection and separation of the first flow path and the second flow path; and
a control device that controls the switching device,
wherein the control device is configured to execute a connection control to cause a thermal medium to flow through the first flow path and the second flow path connected by the switching device when a predetermined circumstance is satisfied when at least one of one or more preset trigger conditions is established, and
wherein the one or more trigger conditions includes at least one of:
an instruction related to an exchange of the thermal medium has been transmitted to the control device from an external tool connected to the vehicle,
the control device has restarted after an auxiliary battery is removed from the vehicle, and
an integrated value of a trip number of the vehicle integrated under a predetermined condition has reached a predetermined value.

2. The thermal management system according to claim 1, wherein the control device controls the switching device such that the connection control is continuously executed until air bleeding of the thermal medium flowing through the first flow path and the second flow path is completed.

3. The thermal management system according to claim 1,
wherein the one or more trigger conditions includes an integrated value of a trip number of the vehicle integrated under the predetermined condition having reached the predetermined value, and
wherein the control device integrates the trip number of the vehicle under a condition that a time during which the first flow path and the second flow path are maintained in a connected state has not reached a predetermined time, and executes the connection control when the predetermined circumstance is satisfied when the integrated value of the trip number reaches the predetermined value.

4. The thermal management system according to claim 1, wherein the predetermined circumstance includes a predetermined time having elapsed from when a vehicle drive device that rotates a drive wheel of the vehicle is in an operating state.

5. The thermal management system according to claim 1,
wherein the control device includes a storage device that stores a value of a parameter,
wherein the control device is configured to update the value of the parameter each time the trip number of the vehicle under the predetermined condition increases,
wherein the value of the parameter becomes a first value when the control device receives an instruction related to an exchange of the thermal medium from an external tool connected to the vehicle, and
wherein the value of the parameter becomes a second value when the control device is restarted after the auxiliary battery is removed from the vehicle.
